(19) United States
(12) Patent Application Publication
(10) Pub. No.: US 2011/0131609 A1
(43) Pub. Date: Jun. 2, 2011

(54) METHOD AND SYSTEM FOR ESTABLISHING A PROGRAM GUIDE WITHIN A VIDEO-ON-DEMAND SERVICE DEPENDING ON THE USER'S MOOD

(76) Inventors: Gérard Delegue, Nozay (FR); Emmanuel Marilly, Nozay (FR)

(21) Appl. No.: 12/992,949

(22) PCT Filed: May 14, 2009
(86) PCT No.: PCT/FR2009/050899

§ 371 Date: Feb. 16, 2011

(30) Foreign Application Priority Data
May 16, 2008 (FR) 08/02698

(51) Int. Cl. H04N 5/445

(52) U.S. Cl. 725/46

(57) ABSTRACT

The invention pertains to a method for establishing a program guide within a video-on-demand service depending on the user's mode, said method comprising the creating of match profiles between videos accessible on-demand and mood parameter values; asking the user to define his or her mood by selecting mood parameters and by assigning values for the selected parameters; using the created profiles to select a list of videos (7) matching the parameter values that define the user's mood; and establishing a program guide regarding the list of selected videos (7).

The invention also pertains to system for establishing a program guide within a video-on-demand service.

The invention pertains to a method for establishing a program guide within a video-on-demand service depending on the user's mood, and a system for establishing a program guide within a video-on-demand service.

Video-on-demand services are enjoying great popularity, whether offered by cable networks, such as the Internet, or non-cable networks, such as telephony.

A very large number of videos are accessible on-demand. In order to make his or her choice, a user of such a service employs an Electronic Service Guide (or ESG) particularly describing services, content, and programming information.

The user of the video-on-demand service generally selects a category (sports, art, history, society, etc.) and a subcategory (for example, in the art category: dance, music, literature, circuses, etc.).

In order to get a glimpse of the content of each of the films offered by the service, the user must himself or herself consult the available information, such as the summary, the list of actors, etc.

The drawback of this service resides in the fact that the choice of categories and subcategories generates a very large list of videos, keeping the user from easily making a choice from the list.

Furthermore, the categories offered to the user are often very basic.

There are systems for establishing program guides which are tailored based on fixed criteria such as age, sex, and preferred film genres. This type of program guide is often basic and inaccurate, ignoring the user's real-time needs.

The purpose of the invention is to remedy the insufficiencies of the prior art with regard to the use of video-on-demand services, by disclosing a method enabling the user to more efficiently choose a video.

To that end, and according to a first aspect, the invention discloses a method for establishing a program guide within a video-on-demand service depending on the user's mood, said method comprising:
creating match profiles between the videos accessible on-demand and mood parameter values,
asking the user to define his or her mood by selecting mood parameters and by assigning values for the selected parameters;
using the created profiles to select a list of videos matching the values of the parameters defining the users mood;
establishing a program guide relating to the list of selected videos.

According to a second aspect, the invention discloses a system for establishing a program guide within a video-on-demand service, said system comprising:
a module for managing mood parameter values, comprising means for asking the user to define his or her mood by selecting mood parameters and by assigning values for the selected parameters;
means for conducting a statistical analysis of mood parameter values with identification data relating to the demanded videos, and to use the created profiles in order to select a list of videos;
a module for creating a program guide comprising means for presenting the identification data of the selected videos to the user.

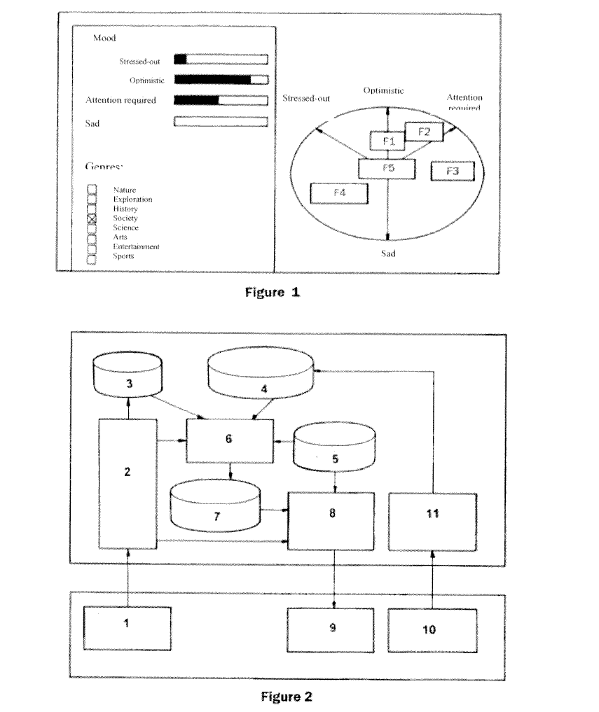

Other features and advantages of the invention will become apparent in the description, with reference to the attached figures depicting the program guide presented to the user (FIG. 1) and the architecture of the system enabling the implementation of an inventive method (FIG. 2).

Below is described a video-on-demand servicing comprising a system for establishing a program guide depending on the user's mood.

This system particularly makes it possible to present the user with a program guide on a terminal 1, such as an Internet-linked television set or a mobile terminal (a telephone, for example).

The system comprises a module for managing mood parameter values, comprising means for asking the user to define his or her mood by selecting mood parameters and by assigning values for the selected parameters.

In particular, the user may use the graphical interface of his or her terminal 1 in order to select mood parameters with which he or she feels are able to suitably define his or her mood.

In one embodiment, the mood parameters may be predefined so that they can be offered to the user by the establishment system. In a variant, the user may determine the parameters that he or she wishes to use, said variant potentially being implemented as a complement to predefined parameters so that the user can add parameters which had not initially been offered by the system.

After selecting mood parameters, the user defines his or her mood by assigning a value to each of the selected parameters. To do so, in the embodiment depicted in FIG. 1, the system displays value bars for each parameter, with the user defining his or her mood by moving a cursor within said bar.

Within the depicted embodiment, the system also provides for displaying a list of video genres, at least one element of said list being tickable by the user so that he or she may also select the genre of films that he or she wishes to view (for example, films about art, sports, history, etc.).

Thus, the program guide may be established depending on both the user's mood and the genre of videos that he or she initially wishes to order. To do so, the system comprises a database 5 accumulating the identifications of the videos accessible on-demand, particularly the genre, title, actors, summary, etc.)

After defining the mood, the management module 2 transmits the mood parameter values to an archive database of mood parameter values 3.

Thus, the mood parameter values defined by the user may be archived, so that the history of all the mood parameter values defined by the user may be utilized, along with their date of definition.

The depicted system further comprises an archive database of the demanded videos' identifications 4, said identifications potentially relating particularly to the genres of the videos, but also to the title, actor, etc.

Thus, the system may also benefit from the identification of the videos demanded by the user along with their date requested.

Based on all this data, the method makes it possible to create match profiles between the videos accessible on-demand and mood parameter values.

To do so, the system comprises a match profile creation module 6, said module comprising means for conducting a statistical analysis of mood parameter values with identification information about the demanded videos.

In particular, the archived mood parameter values may be analyzed with the identification information about the demanded videos in order to correlate the identifications with the mood parameter values example, it is thereby possible to know the identification of a video demanded by the user whenever he or she was in a sad mood to some extent.

Thus, the profile created by the creation module 6 particularly makes it possible to predict the genre of the video that the user may wish to view depending on his or her mood at the moment, depending on the genre of videos previously demanded with that mood.

Furthermore, this profile is refreshed owing to the updating, each time the service is used, of both the mood parameter value archive database 3 and the demanded video identification archive database 4.

The match profile creation module 6 uses the created profiles in order to select a list of videos 7 matching the parameter values that define the user's mood.

This is because the mood parameter values defined at a given moment are transmitted by the mood parameter value management module 2 to the match profile creation module 6. The creation module 6 matches the mood parameter values which are transmitted to it along with the profile that it has created in order to select a list of videos 7 that may appear to interest the user.

The list of videos 7 is selected with the lowest possible distance between the mood of the moment and the created profiles, meaning the videos which were previously selected for that same mood and very similar moods.

The method makes possible to establish a program guide regarding the list of selected videos 7.

To that end, the system includes a program guide creation module 8 comprising means for presenting selected video identification data to the user.

In particular, the establishment of the program guide is carried out by extracting identification data regarding the videos from the list 7.

In the depicted embodiment, the mood parameter value management module 2 transmits to the program guide creation module 8 the data selected by the user regarding the genre of the video that he or she wishes to view.

Thus, the creation module 8, after receiving the list of selected videos 7, may extract identification data regarding the videos from the list that matches the genre selected by the user.

As depicted in FIG. 1, the identification data regarding the relevant videos F1, F2, F3, F4, F5 are presented to the user in the form of a graphical guide 9 on the graphical interface of the terminal 1.

In particular, this identification data relates to the title, a brief description of the video, and the means by which the video is acquired.

The graphical guide 9 also presents, for each presented video F1, F2, F3, F4, F5, the distance away from the selection taken from the match profile (for example, an indication such as a number in order to rank the videos from most relevant to least relevant).

The user may order one of the presented videos F1, F2, F3, F4, F5, using his or her terminal 1. This order 10 will be transmitted by a video order management module 11 to the demanded video identification archive database 4 in order to update it.

The invention also enables the user, after establishing the program guides 9, to modulate the values assigned to the mood parameters in order to edit the list of selected videos 7 within said guide in real time.

1. A method and system for establishing a program guide within a video-on-demand service depending on the user's mood, said method comprising:
creating match profiles between the videos accessible on-demand and mood parameter values, said match profiles being created by statistically analyzing said mood parameter values with the identification data about the demanded videos;
asking the user to define his or her mood by selecting mood parameters and by assigning values for the selected parameters;
using the created profiles to select a list of videos matching the values of the parameters defining the user's mood;
establishing a program guide relating to the list of selected videos (7).

2. A method according to claim 1, wherein the mood parameters to be selected are predefined or determined by the user.

3. A method according to claim 1, wherein the mood parameter values defined by the user are archived, the match profiles being created by statistically analyzing said archived values.

4. A method according to claim 1, wherein the identification of the videos demanded by a user is archived, the match profile being created by statistically analyzing said archived identifications.

5. A method according to claim 1, wherein the establishment of the program guide is carried out by extracting identification data about the videos on the list (7).

6. A method according to claim 5, wherein the video identification data is presented to the user in the form of a graphical guide (9) on the graphical interface of a terminal of the user.

7. A method according to claim 1, wherein, after establishing the program guides, the user may modulate the values assigned to the selected mood parameters in order to edit the list of selected videos within said guide in real time.

8. A system for establishing a program guide within a video-on-demand service depending on the user's mood, said system comprising:
a module for managing mood parameter values, comprising means for asking the user to define his or her mood by selecting mood parameters and by assigning values for the selected parameters;
a module for creating match profiles (6) comprising means for conducting a statistical analysis of mood parameter values with identification data relating to the demanded videos, and to use the created profiles in order to select a list of videos (7);
a module for creating a program guide (8) comprising means for presenting the identification data of the selected videos to the user.

9. An establishment system according to claim 8, said system comprising at least one of the following databases:
a mood parameter value archive database (3);
a demanded video identification archive database (4);
a database of videos accessible on demand (5).
